(19) United States
(12) Patent Application Publication
(10) Pub. No.: US 2020/0144688 A1
(43) Pub. Date: May 7, 2020

(54) METHOD OF MANUFACTURING POSITIVE ELECTRODE COMPLEX FOR LITHIUM AIR BATTERIES, METHOD OF MANUFACTURING LITHIUM AIR BATTERY USING THE POSITIVE ELECTRODE COMPLEX, AND LITHIUM AIR BATTERY INCLUDING THE POSITIVE ELECTRODE COMPLEX

(71) Applicants: Hyundai Motor Company, Seoul (KR); KIA Motors Corporation, Seoul (KR); Industry-University Cooperation Foundation Hanyang University, Seoul (KR)

(72) Inventors: Yong Gu KIM, Suwon-si (KR); Young Joo LEE, Seoul (KR); Se Hwan PARK, Anyang-si (KR); Yun Jung LEE, Seoul (KR)

(21) Appl. No.: 16/535,392

(22) Filed: Aug. 8, 2019

(30) Foreign Application Priority Data
Nov. 5, 2018 (KR) 10-2018-0134300

(51) Int. Cl. H01M 12/08; H01M 4/96; H01M 4/38; H01M 12/06

(52) U.S. Cl. CPC H01M 12/08; H01M 4/96; H01M 2004/028; H01M 12/06; H01M 4/382

(57) ABSTRACT

The present disclosure relates to a method of manufacturing a positive electrode complex for lithium air batteries, wherein a large amount of positive electrode active material including no binder is stacked on a separator through vacuum filtration, instead of using a conventional casting method, to form a positive electrode complex, thereby improving the discharge capacity and high rate characteristics thereof and thus improving the lifespan characteristics of a battery, a method of manufacturing a lithium air battery using the positive electrode complex, and a lithium air battery including the positive electrode complex.

### CROSS-REFERENCE TO RELATED APPLICATION

This application claims priority to and the benefit of Korean Patent Application No. 10-2018-0134300 filed on Nov. 5, 2018, the entire contents of which are incorporated herein by reference.

### FIELD

The present disclosure relates to a method of manufacturing a positive electrode complex for lithium air batteries.

### BACKGROUND

The statements in this section merely provide background information related to the present disclosure and may not constitute prior art.

The capacity of a conventional lithium ion battery is somewhat small in order to satisfy the capacity of a battery required by an energy storage device used in an electric vehicle, etc. For this reason, a lithium air battery having a theoretically high energy per unit weight of about 1140 Wh/kg has attracted considerable attention. However, the capacity per unit area of the lithium air battery, which may be used as an evaluation criterion for an electrochemical energy storage device used in an electric vehicle, is relatively small.

To date, much research has been conducted to increase the capacity of the lithium air battery through structural improvement of a discharge catalyst and a carbon material. However, the capacity per unit area of the lithium air battery does not reach 2 mAh/cm², even though the capacity per unit weight of the lithium air battery is 10000 mAh/g according to research reports. Therefore, the energy density of a lithium air battery is not higher than that of a lithium ion battery. In addition, the lithium air battery exhibits rate characteristics that are too low to provide sufficient capacity at the high-rate speed required for electric vehicles. Here, the term “rate characteristics” means charging and discharging time.

At the stage of commercializing the lithium air battery, therefore, it may be desirable to increase the discharge capacity per unit area of the lithium air battery while maintaining the discharge capacity per unit weight thereof and to achieve high rate characteristics of the lithium air battery. Conventionally, a method of compressing a binder and an active material to manufacture a heavy electrode has been reported. This method increases the amount of the active material. However, the amount of the binder, which accounts for about 10 to 20% of the weight of an electrode, is also increased in proportion to the increased amount of the active material.

The above information disclosed in this Background section is provided only for enhancement of understanding of the background of the disclosure and therefore it may contain information that does not form the prior art that is already known in this country to a person of ordinary skill in the art.

### SUMMARY

The present disclosure describes a method of manufacturing a positive electrode complex for lithium air batteries, wherein a large amount of positive electrode active material is adsorbed on a separator through vacuum filtration, instead of using a conventional casting method, to form a positive electrode complex, thereby increasing the discharge capacity per unit area and achieving high rate characteristics thereof.

The disclosure also provides a method of manufacturing a lithium air battery using the positive electrode complex, wherein the amount of a positive electrode active material is increased, since no binder is included, thereby improving the lifespan characteristics of the lithium air battery.

The present disclosure describes a lithium air battery including the positive electrode complex.

In one aspect, the present disclosure provides a method of manufacturing a positive electrode complex for lithium air batteries, the method including dispersing a positive electrode active material in a dispersing solution to manufacture a positive electrode active material dispersed solution, vacuum-filtering the positive electrode active material dispersed solution on a separator, and drying the separator, on which the positive electrode active material dispersed solution has been vacuum-filtered, to form a positive electrode complex.

The dispersing solution may be alcohol or a mixture of alcohol and distilled water mixed in a volumetric ratio of 1:3 to 6 and wherein the alcohol is at least one selected from a group consisting of isopropyl alcohol, ethanol, or butanol.

The positive electrode active material may be at least one selected from the group consisting of carbon nanotubes, graphene, carbon black, Ketjen black, acetylene black, and Super-P.

The separator may be at least one selected from the group consisting of glass fiber, aluminum oxide (AO), and polyethylene.

The separator may include an electrolyte.

The electrolyte of the separator may include lithium salt and an organic solvent.

At the step of forming the positive electrode complex, the drying may be performed at a temperature of 100 to 140° C. for 1 to 12 hours.

The content of the positive electrode active material in the positive electrode complex may be 3 to 20 mg/cm².

The positive electrode complex may have a thickness of 150 to 450 μm.

In another aspect, the present disclosure provides a method of manufacturing a lithium air battery, the method including providing the positive electrode complex and providing a negative electrode opposite the positive electrode complex, wherein the separator of the positive electrode complex includes an electrolyte.

In a further aspect, the present disclosure provides a lithium air battery including the positive electrode complex, a negative electrode opposite the positive electrode complex, and an electrolyte contained in the separator of the positive electrode complex.

Other aspects of the disclosure are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart showing a method of manufacturing a positive electrode complex for lithium air batteries according to the present disclosure;

FIG. 2A is a photograph showing the front surface (a positive electrode active material) of a positive electrode complex manufactured according to Example 1;

FIG. 2B is a photograph showing the rear surface (a separator) of the positive electrode complex manufactured according to Example 1;

FIG. 2C is a photograph showing the front surface (a positive electrode active material) of a positive electrode complex manufactured according to Example 3;

FIG. 2D is a photograph showing the front surface (a positive electrode active material) of a positive electrode complex manufactured according to Example 4;

FIG. 3 is a graph showing the discharge capacities of lithium air batteries manufactured according to Examples 1 to 4;

FIG. 4 is a graph showing the discharge capacities of lithium air batteries manufactured according to Examples 5 to 8;

FIG. 5 is a graph showing the discharge capacities per unit weight of positive electrode active materials of lithium air batteries manufactured according to Examples 1 and 2 and Comparative Examples 1 and 2;

FIG. 6 is a graph showing the discharge capacities for the entire weight of positive electrodes of the lithium air batteries manufactured according to Examples 1 and 2 and Comparative Examples 1 and 2;

FIG. 7 is a graph showing the high rate of the discharge capacity of the lithium air battery manufactured according to Example 1;

FIG. 8 is a graph showing the high rate of the discharge capacity of a lithium air battery manufactured according to Comparative Example 3;

FIG. 9 is a graph showing the lifespan characteristics based on the discharge current (1.5 mA/cm²) of the lithium air battery manufactured according to Example 1; and

FIG. 10 is a graph showing the lifespan characteristics based on the discharge current (0.5 mA/cm²) of the lithium air battery manufactured according to Example 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The disclosure will be clearly understood from the following aspects with reference to the annexed drawings. However, the present disclosure is not limited, and may be embodied in different forms. The forms herein are suggested only to offer thorough understanding of the disclosed contents and sufficiently inform those skilled in the art of the technical concept of the present disclosure.

Like reference numbers refer to like elements throughout the description of the figures. In the drawings, the sizes of structures are exaggerated for clarity. It will be understood that, although the terms “first”, “second”, etc. may be used herein to describe various elements, corresponding elements should not be understood to be limited by these terms, which are used only to distinguish one element from another. For example, within the scope defined by the present disclosure, a first element may be referred to as a second element, and similarly, a second element may be referred to as a first element. Singular forms are intended to include plural forms as well, unless the context clearly indicates otherwise.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element, or an intervening element may also be present. It will also be understood that, when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

It should be understood that, in the specification, when the range refers to a parameter, the parameter encompasses all figures including end points disclosed within the range. For example, the range of “5 to 10” includes figures of 5, 6, 7, 8, 9, and 10, as well as arbitrary sub-ranges such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include figures such as 10%, 11%, 12% and 13%, as well as 30%, and any sub-ranges of 10% to 15%, 12% to 18%, or 20% to 30%, as well as any figures, such as 10.5%, 15.5% and 25.5%, between appropriate integers that fall within the range.

For a conventional lithium air battery, the amount of an active material included in a positive electrode is increased and the electrode is manufactured by casting in order to increase the capacity per unit area of the battery. In this electrode manufacturing method, however, the amount of a binder is increased in proportion to the increased amount of the active material, whereby the capacity per unit weight of the battery is reduced. In the present disclosure, a positive electrode complex including only a positive electrode active material and a separator without a binder and a dispersant is manufactured using a vacuum filtration method. In the case in which the positive electrode complex is applied to a lithium air battery, the capacity and high rate characteristics of the battery may be improved.

Hereinafter, a positive electrode complex for lithium air batteries according to the present disclosure and a method of manufacturing the same will be described in detail with reference to the accompanying drawings.

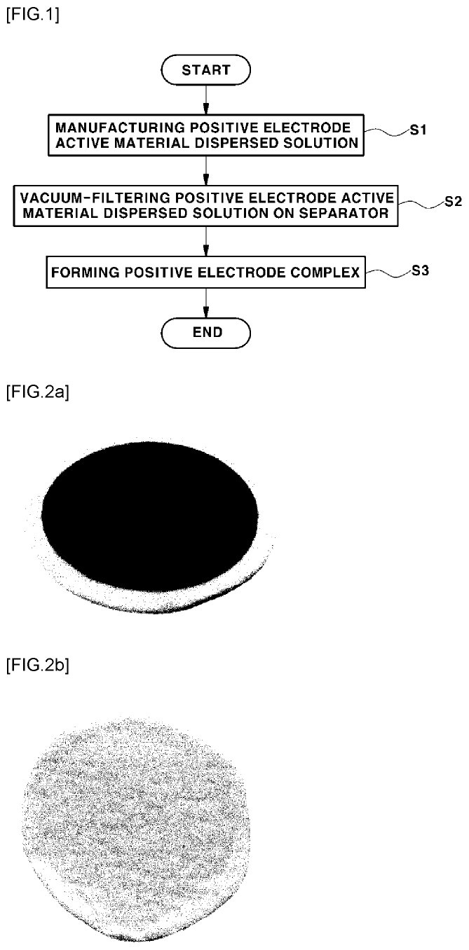

FIG. 1 is a flowchart showing a method of manufacturing a positive electrode complex for lithium air batteries according to the present disclosure. Referring to FIG. 1, the method of manufacturing the positive electrode complex for lithium air batteries includes a step of manufacturing a positive electrode active material dispersed solution (S1), a step of vacuum-filtering the positive electrode active material dispersed solution on a separator (S2), and a step of forming a positive electrode complex (S3).

More specifically, the method of manufacturing the positive electrode complex for lithium air batteries may include a step of dispersing a positive electrode active material in a dispersing solution to manufacture a positive electrode active material dispersed solution, a step of vacuum-filtering the positive electrode active material dispersed solution on a separator, and a step of drying the separator, on which the positive electrode active material dispersed solution has been vacuum-filtered, to form a positive electrode complex.

The respective steps of the method of manufacturing the positive electrode complex for lithium air batteries according to the present disclosure will be described in detail.

### 1) Step of Manufacturing Positive Electrode Active Material Dispersed Solution (S1)

The step of manufacturing the positive electrode active material dispersed solution (S1) may be a step of dispersing a positive electrode active material in a dispersing solution to manufacture a positive electrode active material dispersed solution. At step (S1), the positive electrode active material may be dispersed in the dispersing solution so as to be present in an individual particle state without cohesion.

Depending on the kind of the positive electrode active material, alcohol may be used alone as the dispersing solution, or a mixture of alcohol and distilled water mixed in a volumetric ratio of 1:3 to 6 may be used as the dispersing solution. The alcohol is at least one selected from a group consisting of isopropyl alcohol, ethanol, or butanol.

If the mixing ratio of the alcohol and the distilled water constituting the dispersing solution is 1:less than 3 in a volumetric ratio, the positive electrode active material may not be sufficiently dispersed. If the mixing ratio of the alcohol and the distilled water is 1:greater than 6 in a volumetric ratio, an electrode membrane of the positive electrode complex may not be appropriately formed. The mixing ratio of the alcohol and the distilled water may be 1:3.5 to 1:4.5 in a volumetric ratio.

Since the positive electrode active material exhibits high conductivity, the transmission of electrons is very excellent. Further, since the positive electrode active material exhibits excellent oxygen supplying characteristics, the reversibility of oxygen evolution and reduction reactions may be improved. In general, the positive electrode active material of the lithium air battery is oxygen. In the present disclosure, however, the positive electrode active material is a reaction site in which an electrochemical reaction occurs to generate electrons. A concrete example of the positive electrode active material may be at least one selected from the group consisting of carbon nanotubes, graphene, carbon black, Ketjen black, acetylene black, or Super-P. The graphene may mean graphene, graphene oxide, or reduced graphene oxide (rGO). Comprehensively, the graphene may mean very thin graphite. The positive electrode active material may include carbon nanotubes, graphene, or a mixture thereof.

A material that has low resistance to the movement of ions in an electrolyte and high electrolyte impregnation may be used as the separator. Specifically, at least one selected from the group consisting of glass fiber, aluminum oxide (AO), or polyethylene may be used as the separator. Glass fiber may be used as the separator. The glass fiber separator may have a porosity of 0.2 to 2.0 μm. The aluminum oxide may also be referred to as anodic aluminum oxide (AAO).

The separator may include an electrolyte. The electrolyte may include lithium salt and an organic solvent. The concentration of the lithium salt may be 0.2 to 5.0M in consideration of ion conductivity. The concentration of the lithium salt may be 0.5 to 1.5M in order to achieve ion conductivity suitable for driving the battery.

The lithium salt may be at least one selected from the group consisting of LiNO₃, LiTFSI, LiSCN, LiCl, LiBr, LiI, LiPF₆, LiBF₄, LiSbF₆, LiAsF₆, LiB₁₀Cl₁₀, LiCH₃SO₃, LiCF₃SO₃, LiCF₃CO₂, LiClO₄, LiAlCl₄, Li(Ph)₄, LiC(CF₃SO₂)₃, LiN(FSO₂)₂, LiN(CF₃SO₂)₂, LiN(C₂F₅SO₂)₂, LiN(SFO₂)₂, or LiN(CF₃CF₂SO₂)₂.

The organic solvent may be at least one selected from the group consisting of dimethylacetamide (DMA), tetraethylene glycol dimethyl ether (TEGDME), diethylene glycol diethyl ether (DEGDEE), or dimethyl ether (DME).

At step (S1), the positive electrode active material may be put into the dispersing solution and may be dispersed using an ultrasonic disperser for 5 to 30 minutes. If the dispersion time is less than 5 minutes, the positive electrode active material may not be sufficiently dispersed in the dispersing solution, whereby the positive electrode active material may agglomerate. If the dispersion time is greater than 30 minutes, the positive electrode active material may not be dispersed any more, and heat may be generated, thus deforming the positive electrode active material.

### 2) Step of Vacuum-Filtering Positive Electrode Active Material Dispersed Solution on Separator (S2)

The step of vacuum-filtering the positive electrode active material dispersed solution on the separator (S2) may be a step of vacuum-filtering the positive electrode active material dispersed solution on a separator. At step (S2), the positive electrode active material dispersed solution may be filtered on the separator using a vacuum filter under a vacuum pressure condition of 0.4 pa to 2.5 kpa. Since the positive electrode active material dispersed solution includes no binder, only a large amount of positive electrode active material may be adsorbed on the separator, on which the positive electrode active material dispersed solution has been vacuum-filtered. As a result, it is possible to inhibit or prevent a reduction in the conductivity of the electrode due to the use of a binder and the risk of occurrence of side reactions of the binder.

At step (S2), the positive electrode active material dispersed solution is filtered in a vacuum state, whereby it is possible to manufacture a positive electrode complex having a large amount of positive electrode active material uniformly formed on the separator, compared to a process of manufacturing an electrode using a conventional slurry casting method. In addition, the electrode formed using the conventional slurry casting method includes a binder for settling and fixing the active materials, whereby the capacity per unit area thereof is reduced. In the present disclosure, however, only the positive electrode active material is formed on the separator to thus manufacture the positive electrode complex, whereby the content of the positive electrode active material may become about 1.2 times as much as that of a conventional positive electrode. In addition, an amount of a binder that is proportional to the increased amount of the positive electrode active material is not included, whereby both the discharge capacity per unit weight and the discharge capacity per unit area thereof may be increased. Furthermore, the positive electrode active material is strongly adsorbed on the separator through vacuum filtration, whereby stability of the interface between the separator and the positive electrode active material is high.

### 3) Step of Forming Positive Electrode Complex (S3)

The step of forming the positive electrode complex (S3) may be a step of drying the separator, on which the positive electrode active material dispersed solution has been vacuum-filtered, to form a positive electrode complex. At step (S3), a drying process may be performed in order to increase the force of adhesion between the separator and the positive electrode active material formed on the separator and to evaporate the dispersing solution remaining in the positive electrode active material. Here, the drying process may be performed at a temperature of 100 to 140° C. for 1 to 12 hours. If the drying temperature is high or if the drying time is long, cracks may form between the separator and the positive electrode active material. If the drying temperature is low or if the drying time is short, the dispersing solution may not be sufficiently evaporated, whereby the performance of the electrode may be reduced.

In the positive electrode complex, the content of the positive electrode active material may be 3 to 20 mg/cm². If the content of the positive electrode active material is less than 3 mg/cm², the thickness of the positive electrode complex is too small, whereby it may be difficult to manufacture the battery. If the content of the positive electrode active material is greater than 20 mg/cm², the thickness of the positive electrode complex is too large, whereby the weight of the battery may be increased. The content of the positive electrode active material may be 6 to 17 mg/cm², or in one form, 13 to 16 mg/cm².

The thickness of the positive electrode complex may be changed depending on the content of the active material per unit area thereof. Particularly, if the content of the positive electrode active material is increased, the thickness of the positive electrode complex may also be increased. If the thickness of the positive electrode complex is too large, the distance by which ions or electrons are transmitted is increased, whereby the energy density thereof may be reduced. For this reason, the thickness of the positive electrode complex may be proportional to the content of the positive electrode active material. The thickness of the positive electrode complex may be 150 to 450 μm. If the thickness of the positive electrode complex is less than 150 μm, the increase in the capacity of the battery may be slight. If the thickness of the positive electrode complex is greater than 450 μm, the energy density thereof may be reduced. The thickness of the positive electrode complex may be 160 to 400 μm, or may be 340 to 380 μm.

Meanwhile, a method of manufacturing a lithium air battery according to the present disclosure may include a step of providing the positive electrode complex and a step of providing a negative electrode opposite the positive electrode complex, wherein the separator of the positive electrode complex may include an electrolyte.

In addition, a lithium air battery according to the present disclosure may include the positive electrode complex, a negative electrode opposite the positive electrode complex, and an electrolyte included in the separator of the positive electrode complex.

The lithium air battery may further include a negative electrode current collector formed on the negative electrode. At least one selected from the group consisting of stainless steel, nickel, aluminum, or copper may be used as the negative electrode current collector.

Hereinafter, the present disclosure will be described in more detail with reference to examples. However, the present disclosure is not limited by the following examples.

### Example 1

A dispersing solution including isopropyl alcohol and distilled water mixed in a volumetric ratio of 1:4 was prepared. 20 mg of carbon nanotubes (CNT), as a positive electrode active material, was put into the dispersing solution, and the carbon nanotubes were dispersed using an ultrasonic disperser at a temperature of 60° C. for 30 minutes to manufacture a positive electrode active material dispersed solution. A glass fiber (GF) separator was prepared as a separator. After an electrode was formed, an electrolyte obtained by mixing 1M of LiTFSi with a TEGDME solvent was introduced into the separator. After the glass fiber separator was placed on the porous bottom of a vacuum filter, the positive electrode active material dispersed solution was vacuum-filtered at a content of 8 mg/cm² in a vacuum pressure of 1.5 kpa for 30 minutes. Subsequently, the separator, on which the positive electrode active material dispersed solution was vacuum-filtered, was dried at a temperature of 110° C. for 4 hours to manufacture a positive electrode complex. Subsequently, lithium foil having a thickness of 500 μm, serving as a negative electrode, was bonded to the separator of the positive electrode complex. Subsequently, a stainless steel (SUS) negative electrode current collector was bonded to the negative electrode, and pressing was performed using a general method to manufacture a lithium air battery.

### Examples 3 and 4

Lithium air batteries were manufactured using the same method as in Example 1, except that positive electrode complexes were manufactured using the ingredients shown in Table 1 below.

### Examples 5 to 8

Lithium air batteries were manufactured using the same method as in Example 1, except that the content of each positive electrode active material dispersed solution was changed and positive electrode complexes were manufactured using the ingredients shown in Table 1 below. Specifically, each positive electrode active material dispersed solution was vacuum-filtered on a separator at a content of 15 mg/cm².

### Examples 2 and 6

The electrode active material dispersed solution manufactured according to Example 1 was prepared. An aluminum oxide filter was prepared as a filter. After the aluminum oxide filter was placed on the porous bottom of a vacuum filter, the positive electrode active material dispersed solution was vacuum-filtered at contents of 8 mg/cm² and 15 mg/cm² in a vacuum pressure of 1.5 kpa for 30 minutes. Subsequently, the aluminum oxide filter, on which the positive electrode active material dispersed solution was vacuum-filtered, was dried at a temperature of 110° C. for 4 hours. Subsequently, a film-shaped positive electrode formed on the aluminum oxide filter was separated and stacked on a glass fiber (GF) separator. At this time, a separator impregnated with an electrolyte obtained by mixing 1M of LiTFSi with a TEGDME solvent was used as the glass fiber separator. Subsequently, the glass fiber separator and a lithium foil negative electrode having a thickness of 500 μm were sequentially bonded to the positive electrode. Subsequently, a SUS negative electrode current collector was bonded to the negative electrode, and pressing was performed using a general method to manufacture lithium air batteries.

TABLE 1

| | Positive electrode active | |
|---|---|---|
| Classification | material | Separator |
| Example 1 | Carbon nanotubes | Glass fiber |
| Example 2 | Carbon nanotubes | Glass fiber |
| Example 3 | Ketjen black | Glass fiber |
| Example 4 | Super-P | Glass fiber |
| Example 5 | Carbon nanotubes | Glass fiber |
| Example 6 | Carbon nanotubes | Glass fiber |
| Example 7 | Ketjen black | Glass fiber |
| Example 8 | Super-P | Glass fiber |

### Comparative Example 1

Carbon nanotubes, as a positive electrode active material, and polyvinylidene fluoride (PVdF), as a binder, were mixed in a weight ratio of 8:2, and the mixture was dispersed in an N-methyl-2-pyrrolidone solvent to manufacture a positive electrode slurry. Subsequently, the positive electrode slurry was cast to nickel form, as a positive electrode current collector, at a content of 8 mg/cm² to form a positive electrode layer. A glass fiber (GF) separator was prepared as a separator. After an electrode was formed, an electrolyte obtained by mixing 1M of LiTFSi with a TEGDME solvent was introduced into the separator. Subsequently, the glass fiber separator and a lithium foil negative electrode having a thickness of 500 μm were sequentially bonded to the positive electrode layer. Subsequently, a SUS negative electrode current collector was bonded to the negative electrode, and pressing was performed using a general method to manufacture a lithium air battery.

### Comparative Example 2

A lithium air battery was manufactured using the same method as in Comparative Example 1, except for the composition of a positive electrode current collector and a positive electrode layer. A gas diffusion layer (GDL) made of carbon paper was used as the positive electrode current collector. In addition, a positive electrode slurry was cast to the gas diffusion layer at a content of 8 mg/cm² to form a positive electrode layer.

### Comparative Example 3

Carbon nanotubes, as a positive electrode active material, and polytetrafluoroethylene (PTFE), as a binder, were mixed in a weight ratio of 8:2 after being introduced into an agate mortar to manufacture a gel-type positive electrode slurry having a phase between a liquid phase and a solid phase. Subsequently, the positive electrode slurry was cast to nickel form, as a positive electrode current collector, to form a positive electrode layer. At this time, the content of the positive electrode active material included in the positive electrode layer was 7 to 8 mg/cm². Subsequent processes were performed in the same manner as in Comparative Example 1 to manufacture a lithium air battery.

### Experimental Example 1: Evaluation of Contents of Positive Electrode Active Materials and Discharge Capacities of Lithium Air Batteries

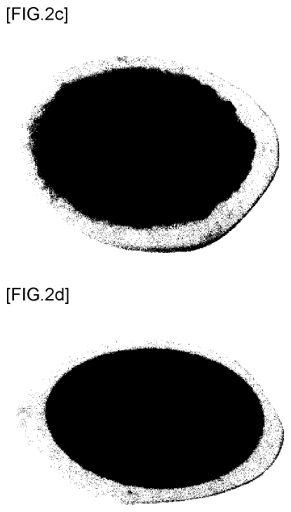

The contents of the positive electrode active materials in the lithium air batteries manufactured according to Examples 1 to 4 and the thicknesses of the positive electrode complexes thereof were measured. Subsequently, the lithium air batteries were discharged in an oxygen atmosphere under conditions of a pressure of 2 bar, a voltage of 2.3 V, and a current of 1.5 mA/cm², and then the discharge capacities of the lithium air batteries were measured. The results are shown in Table 2 below and in FIGS. 2A to 2D, 3 and 4. FIGS. 2A and 2B are photographs respectively showing the front surface (the positive electrode active material) and the rear surface (the separator) of the positive electrode complex manufactured according to Example 1. FIGS. 2C and 2D are photographs respectively showing the front surface (the positive electrode active material) of the positive electrode complex manufactured according to Example 3 and the front surface (the positive electrode active material) of the positive electrode complex manufactured according to Example 4.

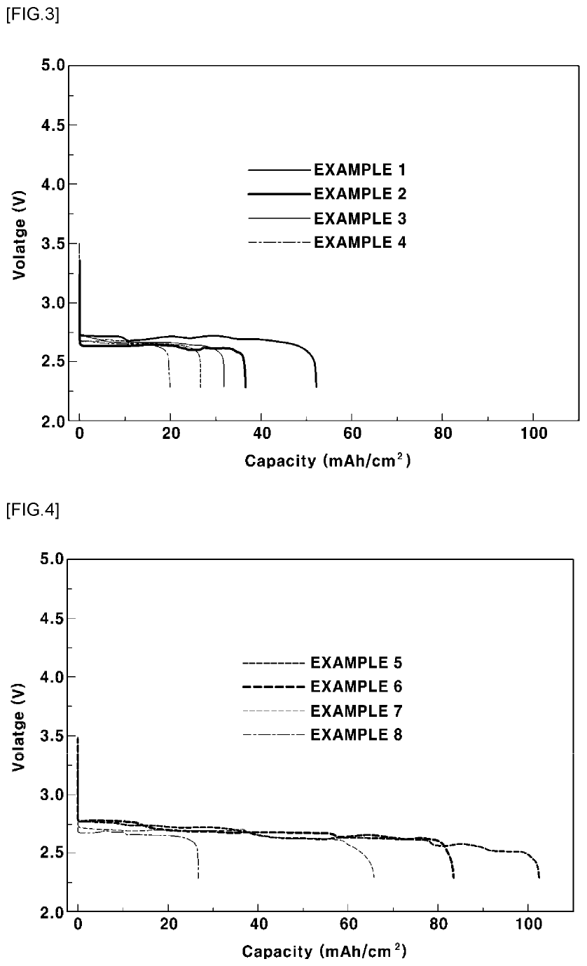

FIG. 3 is a graph showing the discharge capacities of the lithium air batteries manufactured according to Examples 1 to 4. FIG. 4 is a graph showing the discharge capacities of the lithium air batteries manufactured according to Examples 5 to 8.

TABLE 2

| | | | Content of | Thick- | |
|---|---|---|---|---|---|
| | | | positive | ness of | |
| | Positive | | electrode | positive | |
| | electrode | | active | electrode | Discharge |
| Classifica- | active | Sepa- | material | complex | capacity |
| tion | material | rator | (mg/cm²) | (μm) | (mAh/cm²) |
| Example 1 | Carbon | Glass | 7 to 8 | 160 | 56.8 |
| | nanotubes | fiber | | | |
| Example 2 | Carbon | Glass | 7 to 8 | 180 | 51.2 |
| | nanotubes | fiber | | | |
| Example 3 | Ketjen black | Glass | 7 to 8 | — | 52.2 |
| | | fiber | | | |
| Example 4 | Super-P | Glass | 7 to 8 | — | 26.7 |
| | | fiber | | | |
| Example 5 | Carbon | Glass | 14 to 15 | 360 | 102.5 |
| | nanotubes | fiber | | | |
| Example 6 | Carbon | Glass | 14 to 15 | 420 | 83.4 |
| | nanotubes | fiber | | | |
| Example 7 | Ketjen black | Glass | 14 to 15 | — | 69 |
| | | fiber | | | |
| Example 8 | Super-P | Glass | 14 to 15 | — | 36.6 |
| | | fiber | | | |

It can be seen from Table 2 and FIGS. 3 and 4 that the thicknesses of the positive electrode complexes manufactured according to Examples 1 to 8 were different from each other depending on the content of the positive electrode active material and whether a separator having porosity was used. In particular, it can be seen that, although the positive electrode complexes manufactured according to Examples 1, 2, 5 and 6 used the same positive electrode material, the integrated positive electrode complexes manufactured according to Examples 1 and 5 exhibited stronger force of interface adhesion between the positive electrode active material and the separator than the positive electrode complexes manufactured according to Examples 2 and 6, in each of which the film-shaped positive electrode was separated and stacked on the separator. As a result, the thicknesses of the positive electrode complexes manufactured according to Examples 1 and 5 were smaller than those of the positive electrode complexes manufactured according to Examples 2 and 6, respectively. As the thickness of the positive electrode complex is reduced, the distance by which lithium ions and oxygen ions move is reduced, whereby a larger amount of positive electrode active material may participate in the reaction. Consequently, it can be seen that the discharge capacities of the positive electrode complexes manufactured according to Examples 1 and 5 were increased.

In addition, it can be seen that the discharge capacities of the positive electrode complexes manufactured according to Examples 1 and 5 are larger than those of the positive electrode complexes manufactured according to Examples 3, 4, 7, and 8. As a result, it can be seen that, in the case in which a porous carbon material, rather than a powder-type carbon material, is used as the positive electrode active material, oxygen actively moves due to excellent permeability, whereby a positive electrode complex having a relatively small thickness is formed and thus the discharge capacity of the positive electrode complex is increased.

### Experimental Example 2: Evaluation of Discharge Capacities of Lithium Air Batteries

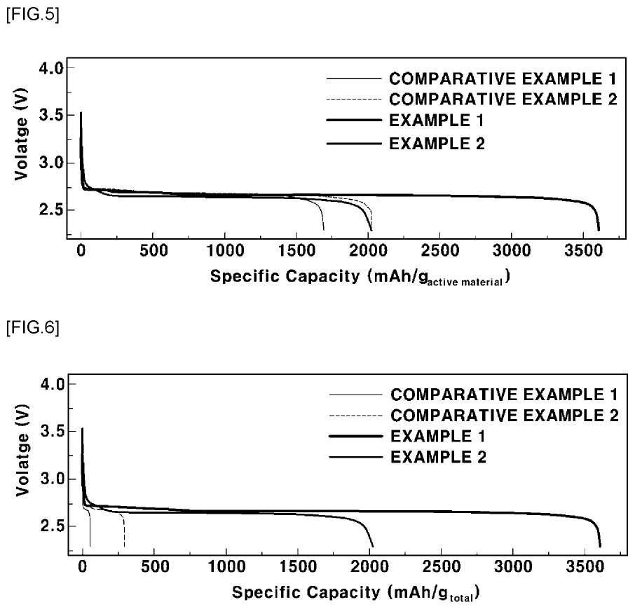

In order to evaluate the discharge capacities of the lithium air batteries manufactured according to Examples 1 and 2 and Comparative Examples 1 and 2, the lithium air batteries were discharged in an oxygen atmosphere under conditions of a pressure of 2 bar, a voltage of 2.3 V, and a current of 1.5 mA/cm², and then the full discharge capacities of the lithium air batteries were measured. The results are shown in Table 3 below and in FIGS. 5 and 6. FIG. 5 is a graph showing the discharge capacities per unit weight of the positive electrode active materials of the lithium air batteries manufactured according to Examples 1 and 2 and Comparative Examples 1 and 2. FIG. 6 is a graph showing the discharge capacities for the entire weight of the positive electrodes of the lithium air batteries manufactured according to Examples 1 and 2 and Comparative Examples 1 and 2.

TABLE 3

| | | | Discharge |
|---|---|---|---|
| | Content of | | capacity |
| | positive | Discharge capacity | for entire |
| | electrode | per unit weight of | weight of |
| | active | positive electrode | positive |
| Classifica- | material | active material | electrode |
| tion | (mg/cm²) | (mAh/g_{active material}) | (mAh/gₜₒₜₐₗ) |
| Example 1 | 7 to 8 | 3608 | 3608 |
| Example 2 | 7 to 8 | 2024 | 2024 |
| Comparative | 1.44 | 2024 | 289 |
| Example 1 | | | |
| Comparative | 0.9 | 1696 | 50 |
| Example 2 | | | |

1) The total weight of the positive electrode means the weight of the positive electrode complex for each of Examples 1 and 2 and the weight of the positive electrode layer for each of Comparative Examples 1 and 2.

It can be seen from Table 3 and FIGS. 5 and 6 that the lithium air batteries manufactured according to Examples 1 and 2 had high contents of positive electrode active materials, since no binder was included, whereby the discharge capacities thereof were increased. In addition, it can be seen that the positive electrode complexes are made of only the positive electrode active materials, whereby the discharge capacities per unit weight of the positive electrode active materials of the lithium air batteries and the discharge capacities for the entire weight of the positive electrodes of the lithium air batteries were the same.

In contrast, it can be seen that the positive electrode layer formed by casting according to Comparative Example 1 included the binder, whereby the lithium air battery had a relatively low content of positive electrode active materials. In particular, it can be seen that the discharge capacity for the entire weight of the positive electrode of the lithium air battery was reduced, since the positive electrode layer included the binder. However, the discharge capacity per unit weight of the positive electrode active material of the lithium air battery had the same value as in Example 2, since only the positive electrode active material was considered.

It can be seen that, for Comparative Example 2, the carbon paper was included as the positive electrode current collector, whereby the content of the positive electrode active material in the positive electrode layer was the lowest. As a result, the discharge capacity per unit weight of the positive electrode active material in the positive electrode layer was also low. The discharge capacity for the entire weight of the positive electrode was also was the lowest.

When converting based on all masses included in the positive electrode at the time the battery is actually designed, since the content of the positive electrode active material is increased and an amount of a binder proportional to the increased amount of the positive electrode active material is not included, it can be seen that the discharge capacity per unit weight thereof may be increased.

### Experimental Example 3: Evaluation of High Rates of Discharge Capacities of Lithium Air Batteries

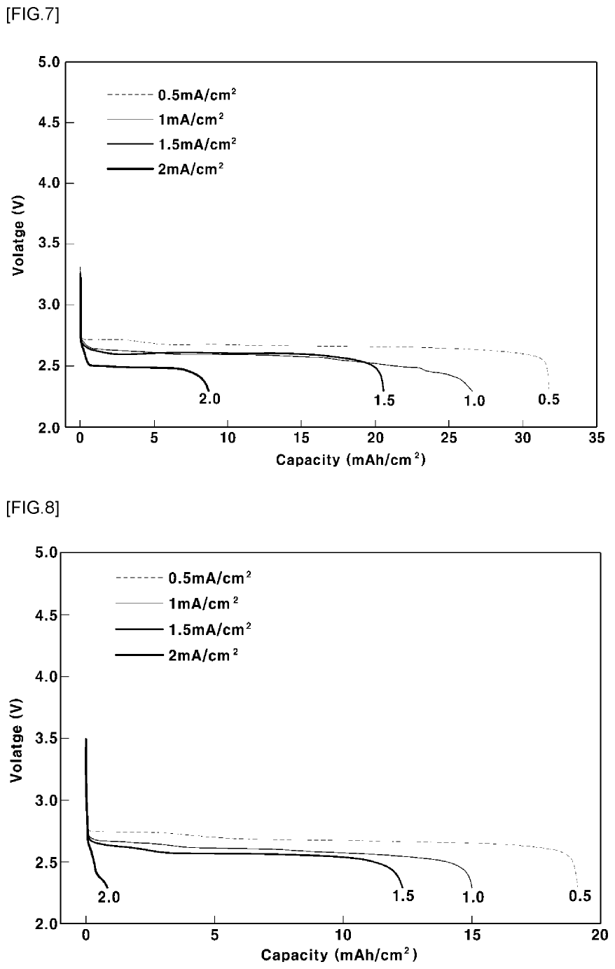

In order to evaluate high rates of the discharge capacities of the lithium air batteries manufactured according to Example 1 and Comparative Example 3, the lithium air batteries were discharged in an oxygen atmosphere under conditions of a pressure of 2 bar, a voltage of 2.3 V, and a current of 0.5, 1, 1.5, and 2 mA/cm², and then the discharge capacities of the lithium air batteries were measured. The results are shown FIGS. 7 and 8.

FIG. 7 is a graph showing the high rate of the discharge capacity of the lithium air battery manufactured according to Example 1. FIG. 8 is a graph showing the high rate of the discharge capacity of a lithium air battery manufactured according to Comparative Example 3. Referring to FIGS. 7 and 8, at a low rate having a current of 0.5 mA/cm², the discharge capacities of the lithium air batteries manufactured according to Example 1 and Comparative Example 3 were 31.8 mAh/cm² and 19.1 mAh/cm², respectively. That is, it can be seen that the discharge capacity of the lithium air battery manufactured according to Example 1 was about 1.5 times as high as that of the lithium air battery manufactured according to Comparative Example 3. In addition, at a high rate having a current of 2 mA/cm², the discharge capacities of the lithium air batteries manufactured according to Example 1 and Comparative Example 3 were 8.7 mAh/cm² and 0.8 mAh/cm², respectively. That is, it can be seen that the discharge capacity of the lithium air battery manufactured according to Example 1 was about 10 times or more higher than that of the lithium air battery manufactured according to Comparative Example 3.

As a result, it can be seen that, in the case in which the binder is included in the active material and then the electrode is manufactured by casting, as in Comparative Example 3, the capacity of the lithium air battery is reduced due to an increase in the resistance in the lithium air battery. In contrast, it can be seen that the lithium air battery manufactured according to Example 1 included no polymer binder having heat transfer property, whereby a reduction of electrical conductivity was inhibited or prevented and thus the lithium air battery was more stably discharged at a high-rate current.

### Experimental Example 4: Evaluation of Lifespan Characteristics of Lithium Air Batteries

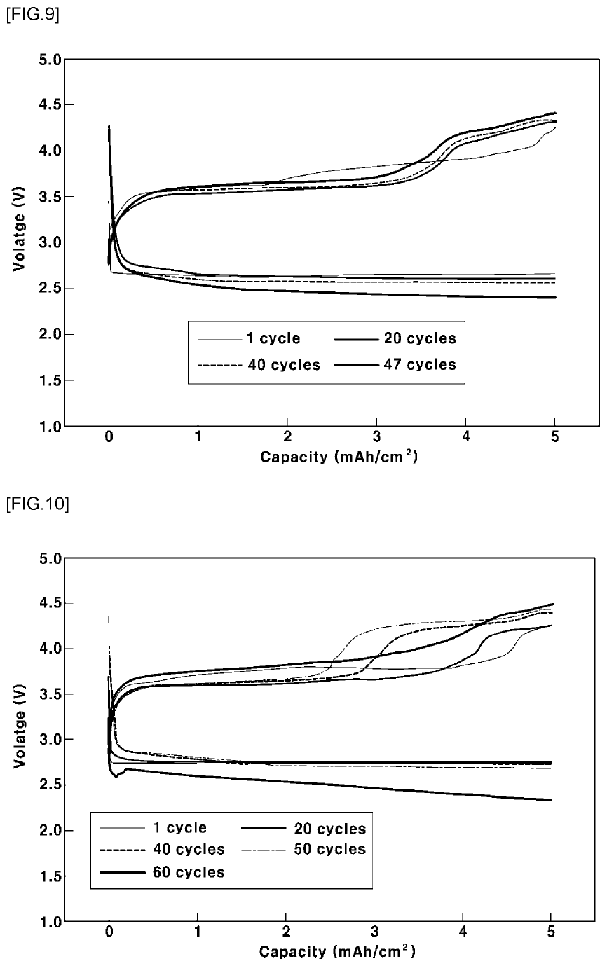

In order to evaluate the lifespan characteristics of the lithium air battery manufactured according to Example 1, the lithium air battery was charged and discharged in an oxygen atmosphere under conditions of a pressure of 2 bar, a voltage of 2.3 to 4.5 V, and a current of 0.5 to 1.5 mA/cm². The results are shown in FIGS. 9 and 10.

FIG. 9 is a graph showing the lifespan characteristics based on the discharge current (1.5 mA/cm²) of the lithium air battery manufactured according to Example 1. Referring to FIG. 9, the lifespan of the lithium air battery was 47 cycles when the lithium air battery was discharged at 1.5 mA/cm² and charged at 0.5 mA/cm².

FIG. 10 is a graph showing the lifespan characteristics based on the discharge current (0.5 mA/cm²) of the lithium air battery manufactured according to Example 1. Referring to FIG. 10, the lifespan of the lithium air battery was 60 cycles when the lithium air battery was discharged at 0.5 mA/cm² and charged at 0.5 mA/cm². It can be seen that the lifespan of the lithium air battery in FIG. 10 was longer than that of the lithium air battery in FIG. 9.

As a result, it can be seen that the lifespan characteristics of the lithium air battery manufactured according to Example 1 can be adjusted based on the intensity of the discharge current and in particular that when the lithium air battery is discharged as a low discharge current, the lifespan of the lithium air battery is increased.

As apparent from the foregoing, the positive electrode complex for lithium air batteries according to the present disclosure is formed by vacuum-filtering the positive electrode active material dispersed solution on the separator, instead of manufacturing an electrode using a conventional casting method. Consequently, it is possible to form a positive electrode complex having a large amount of positive electrode active material contained therein.

In addition, the positive electrode complex for lithium air batteries according to the present disclosure is formed by adsorbing the positive electrode active material on the separator through vacuum filtration, whereby the stability of the interface between the separator and the positive electrode active material is high. Furthermore, no binder, which reduces electrical conductivity, is included, whereby discharge capacity may be increased and high rate characteristics based on the amount of active material may be improved due to the improvement of electrical conductivity.

In addition, the lithium air battery according to the present disclosure is manufactured using an integrated positive electrode complex, instead of using a positive electrode and a separator as individual layers. Consequently, it is possible to increase the content of the positive electrode active material. Furthermore, no binder is included, even though the amount of the active material increased, whereby it is possible to reduce the weight of the electrode due to the increased amount of the active material.

The effects of the present disclosure are not limited to those mentioned above. It should be understood that the effects of the present disclosure include all effects that can be inferred from the foregoing description of the present disclosure.

The disclosure has been described in detail herein. However, it will be appreciated by those skilled in the art that changes may be made without departing from the principles and spirit of the disclosure.

What is claimed is:

1. A method of manufacturing a positive electrode complex for lithium air batteries, the method comprising:
dispersing a positive electrode active material in a dispersing solution to manufacture a positive electrode active material dispersed solution;
vacuum-filtering the positive electrode active material dispersed solution on a separator; and
drying the separator, on which the positive electrode active material dispersed solution has been vacuum-filtered, to form a positive electrode complex.

2. The method according to claim 1, wherein the dispersing solution is alcohol or a mixture of alcohol and distilled water mixed in a volumetric ratio of 1:3 to 6 and,
wherein the alcohol is at least one selected from a group consisting of isopropyl alcohol, ethanol, or butanol.

3. The method according to claim 1, wherein the positive electrode active material is at least one selected from a group consisting of carbon nanotubes, graphene, carbon black, Ketjen black, acetylene black, or Super-P.

4. The method according to claim 1, wherein the separator is at least one selected from a group consisting of glass fiber, aluminum oxide (AO), or polyethylene.

5. The method according to claim 1, wherein the separator comprises an electrolyte.

6. The method according to claim 5, wherein the electrolyte of the separator comprises lithium salt and an organic solvent.

7. The method according to claim 1, wherein, at the step of forming the positive electrode complex, the drying is performed at a temperature of 100 to 140° C. for 1 to 12 hours.

8. The method according to claim 1, wherein a content of the positive electrode active material in the positive electrode complex is 3 to 20 mg/cm².

9. The method according to claim 1, wherein the positive electrode complex has a thickness of 150 to 450 μm.

10. A method of manufacturing a lithium air battery, the method comprising:
providing the positive electrode complex manufactured using the method according to claim 1; and
providing a negative electrode opposite the positive electrode complex, wherein
the separator of the positive electrode complex comprises an electrolyte.

11. A lithium air battery comprising:
the positive electrode complex manufactured using the method according to claim 1;
a negative electrode opposite the positive electrode complex; and
an electrolyte contained in the separator of the positive electrode complex.
